(19) United States
(12) Patent Application Publication
(10) Pub. No.: US 2026/0336191 A1
(43) Pub. Date: Oct. 29, 2026

(54) POLYMERIC COMPOSITIONS CONTAINING MALEATED ETHYLENE-ALKYL ACRYLATE COPOLYMER FOR FORMING FILM

(71) Applicant: Westlake Longview Corporation, Houston, TX (US)

(72) Inventors: Kranthi Chaitanya DANDA, Longview, TX (US); Darren Lavon SMITH, Kilgore, TX (US)

(73) Assignee: Westlake Longview Corporation, Houston, TX (US)

(21) Appl. No.: 19/657,496

(22) Filed: Apr. 24, 2026

Related U.S. Application Data
(60) Provisional application No. 63/795,952, filed on Apr. 28, 2025.

(51) Int. Cl. B29C 49/00; B29B 9/06; B29B 9/12; B29B 17/04; B29C 49/04; B29K 23/00; B29K 77/00; B29K 96/02; B29K 105/26; B29L 7/00; B29L 9/00

(52) U.S. Cl. CPC B29C 49/0005; B29B 9/06; B29B 9/12; B29B 17/0412; B29C 49/04; B29B 2017/042; B29B 2017/0424; B29K 2023/0625; B29K 2023/0633; B29K 2023/086; B29K 2077/00; B29K 2096/02; B29K 2105/26; B29K 2995/0022; B29K 2995/0077; B29K 2995/0089; B29L 2007/008; B29L 2009/00

(57) ABSTRACT

Disclosed is a polymeric composition useful for making films. The composition includes an ungrafted ethylene-based polymer, a polar polymer, and a compatibilizer comprising an ethylene-alkyl acrylate copolymer (EAA) grafted with maleic anhydride. The maleated EAA has a melt index of 25 to 250 g/10 minutes and comprises 1.3 to 2.0 wt % of maleic anhydride. The ungrafted ethylene-based polymer and the polar polymer may be sourced from recycled multilayer barrier films used in packaging. Films made from the composition can have a combination of improved visual characteristics, performance, and/or processability.

### CROSS-REFERENCE TO RELATED APPLICATION/PRIORITY CLAIM

Priority of U.S. Provisional Patent Application No. 63/795,952 filed on Apr. 28, 2025, is hereby claimed; the entire content of which is hereby incorporated by reference.

### FIELD OF THE INVENTION

The invention generally relates to polymeric compositions useful for forming films, films containing the compositions, and processes for making the films.

### BACKGROUND OF THE INVENTION

Compatibilization of polar polymers, such as polyamide (PA) and/or ethylene-vinyl alcohol copolymer (EVOH), with non-polar polymers, such as polyethylene (PE), is commonly carried out with maleic anhydride (MAH) grafted polymers. However, such multi-component compositions can produce films having less than desirable optical properties, mechanical properties, and/or processability.

Thus, there is a need in the art for compositions that can form films containing PE and PA and/or EVOH (e.g., from recycled multilayer barrier films) having a combination of desirable film characteristics, performance, and/or processability.

The present invention addresses this need as well as others, which will become apparent from the following description and the appended claims.

### SUMMARY OF THE INVENTION

The invention is as set forth in the appended claims.

Briefly, in one aspect, the present invention provides a composition comprising:
(a) an ungrafted ethylene-based polymer;
(b) a polar polymer comprising a polyamide, an ethylene-vinyl alcohol copolymer (EVOH), or both; and
(c) a compatibilizer comprising an ethylene-alkyl acrylate copolymer (EAA) grafted with maleic anhydride (MAH-g-EAA),
wherein the alkyl in the EAA is methyl or n-butyl, and
wherein the MAH-g-EAA has a melt index of 25 to 250 g/10 minutes and comprises 1.3 to 2.0 wt % of maleic anhydride, based on the weight of the MAH-g-EAA.

The composition is particularly useful for making monolayer blown films. Thus, in a second aspect, the invention provides a monolayer blown film comprising the composition.

In a third aspect, the invention provides a method of making a monolayer blown film from the composition.

In various embodiments, the method includes the steps of:
(a) providing a multilayer barrier film which comprises a tie layer comprising the compatibilizer;
(b) shredding and densifying the multilayer barrier film to form crude pellets; and
(c) forming the monolayer blown film from the crude pellets.

In various other embodiments, the method includes the steps of:
(a) providing a multilayer barrier film which is free of the compatibilizer;
(b) shredding and densifying the multilayer barrier film to form crude pellets;
(c) adding the compatibilizer to the multilayer barrier film during step (b) to form the crude pellets; and
(d) forming the monolayer blown film from the crude pellets.

In yet various other embodiments, the method includes the steps of:
(a) melt blending the ungrafted ethylene-based polymer, the polar polymer, and the compatibilizer to form new pellets; and
(b) forming a monolayer blown film from the new pellets.

### BRIEF DESCRIPTION OF THE DRAWINGS

FIGS. 1A-1C show optical microscopy images of the blown film formed from Example 2.

FIGS. 2A-2D show optical microscopy images of the blown film formed from Example 3.

FIGS. 3A-3C show optical microscopy images of the blown film formed from Example 4.

FIGS. 4A-4C show optical microscopy images of the blown film formed from Example 5.

FIGS. 5A-5C show optical microscopy images of the blown film formed from Example 6.

FIGS. 6A-6C show optical microscopy images of the blown film formed from Example 7.

FIGS. 7A-7C show optical microscopy images of the blown film formed from Example 8.

### DETAILED DESCRIPTION OF THE INVENTION

It has been surprisingly discovered that monolayer films having improved optical and/or mechanical properties can be made from a blend of polar and non-polar polymers using a compatibilizer having a certain melt index and maleation level. The improved optical and/or mechanical properties include one or more of the following: higher gloss; lower haze; greater clarity; greater strength; higher elongation; greater toughness; higher dart impact; higher Elmendorf tear; greater puncture resistance; fewer voids; less gels; and greater miscibility. The compatibilizer can also offer the additional benefit of having improved processability.

### Composition

In one aspect, the present invention provides a composition comprising:
(a) an ungrafted ethylene-based polymer;
(b) a polar polymer comprising a polyamide, an ethylene-vinyl alcohol copolymer (EVOH), or both; and
(c) a compatibilizer comprising an ethylene-alkyl acrylate copolymer (EAA) grafted with maleic anhydride (MAH-g-EAA),
wherein the alkyl in the EAA is methyl or n-butyl, and
wherein the MAH-g-EAA has a melt index of 25 to 250 g/10 minutes and comprises 1.3 to 2 wt % of maleic anhydride, based on the weight of the MAH-g-EAA.

The composition may contain from 1 to 99 wt %, from 10 to 99 wt %, from 20 to 99 wt %, from 30 to 99 wt %, from 40 to 99 wt %, from 50 to 99 wt %, from 55 to 99 wt %, from 60 to 99 wt %, from 65 to 99 wt %, from 70 to 99 wt %, from 75 to 99 wt %, from 80 to 99 wt %, from 85 to 99 wt %, from 90 to 99 wt %, from 93 to 99 wt %, from 95 to 99 wt %, or from 97 to 99 wt % of the ungrafted ethylene-based polymer, based on the weight of the composition.

In various embodiments, the composition may contain at least 50 wt %, at least 60 wt %, at least 70 wt %, at least 80 wt %, at least 90 wt %, at least 95 wt %, at least 97 wt %, or at least 99 wt % of the ungrafted ethylene-based polymer, based on the weight of the composition.

In various embodiments, the composition includes a polyamide.

In various other embodiments, the composition excludes a polyamide.

If included, the composition may contain from 0.1 to 40 wt %, from 0.1 to 35 wt %, 0.1 to 30 wt %, from 0.1 to 25 wt %, from 0.1 to 20 wt %, from 0.1 to 15 wt %, from 0.1 to 10 wt %, or from 0.1 to 5 wt % of a polyamide, based on the weight of the composition.

In various embodiments, the composition includes an EVOH.

In various other embodiments, the composition excludes an EVOH.

If included, the composition may contain from 0.1 to 30 wt %, from 0.1 to 25 wt %, from 0.1 to 20 wt %, from 0.1 to 15 wt %, from 0.1 to 10 wt %, or from 0.1 to 5 wt % of the EVOH, based on the weight of the composition.

The quantity of compatibilizer used in the composition can vary based on factors such as the type and amount of the polar polymer present, the desired degree of compatibilization, and the degree of maleation of the compatibilizer.

Generally, the composition may contain from 0.1 to 15 wt %, from 0.1 to 10 wt %, from 1 to 15 wt %, or from 1 to 10 wt % of the compatibilizer, based on the weight of the composition.

In various embodiments, the ungrafted ethylene-based polymer, the polyamide, the EVOH, the compatibilizer, or combinations thereof may be sourced from post-industrial or post-consumer waste. For example, the composition may include one or more components from recycled multilayer packaging materials (e.g., flexible barrier films) or scrap materials generated while making the multilayer packaging materials.

Post-industrial waste refers to manufacturing scrap, while post-consumer waste refers to waste produced by the end-user.

The inventive composition may contain one or more conventional additives in typical amounts. Examples of the additives include heat stabilizers, antioxidants, lubricants, antistatic agents, dispersants, plasticizers, flame retardants, viscosity enhancers, ultraviolet light absorbers, light stabilizers, slip agents, anti-blocking agents, dyes, pigments, and fillers.

The composition may be a concentrate/masterbatch or a fully formulated/compounded formulation.

The terms “masterbatch” and “concentrate” are used interchangeably. They refer to a composition that has a higher concentration of any component (e.g., the compatibilizer) than a fully compounded or a fully formulated composition. The masterbatch can include a carrier resin. One or more of the ungrafted ethylene-based polymers may be used as the carrier resin. The masterbatch is typically diluted with a letdown resin to form the fully formulated composition. One or more of the ungrafted ethylene-based polymers may be used as the letdown resin. The letdown resin may be the same or different polymer than the carrier resin. The masterbatch can be formed by dry mixing and/or melt blending the components. The fully formulated composition is what is used to form a shaped object, such as a film.

The composition may be prepared by melt blending the ingredients by any suitable method, such as by single-screw extrusion, co- or counter-rotating twin-screw extrusion, batch mixers, and any combination thereof. The ingredients may be introduced in the form of pellet, shred, grind, regrind, fluff, scrap, or any combination thereof.

Alternatively, the composition may be prepared by passing a film or films (containing one or more of the composition ingredients) through film shredding and densifying equipment, such as an EREMA plastic recycling system. One or more ingredients of the composition may enter the recycling system in film form and may exit in pellet form, grind form, fluff form, or any combination thereof.

The film(s) introduced into the plastic recycling system may be virgin, post-consumer recycled (PCR), post-industrial recycled (PIR), or any combination thereof.

In various embodiments, the composition excludes an added nanocomposite. A nanocomposite refers to a composite of clay (e.g., montmorillonite) and polyamide.

In various embodiments, the composition is free of an added metal salt.

### Ethylene-Based Polymer

The terms “ethylene-based polymer” and “polyethylene” are used interchangeably herein. They refer to a polymer that contains more than 50 weight percent of polymerized ethylene monomer (based on the total amount of polymerizable monomers) and, optionally, may contain at least one comonomer. Ethylene-based polymer includes ethylene homopolymer and ethylene copolymers (meaning units derived from ethylene and one or more comonomers). Examples of ethylene-based polymer (polyethylene) include high-density polyethylene (HDPE), low-density polyethylene (LDPE), linear low-density polyethylene (LLDPE), very-low-density polyethylene (VLDPE), VLDPE with long branches, and ultra-low-density polyethylene (ULDPE) (also known as plastomers).

Generally, polyethylene may be produced in gas-phase, fluidized-bed reactors; liquid-phase, slurry process reactors; or liquid-phase, solution process reactors, using a heterogeneous catalyst system, such as Ziegler-Natta catalyst; a homogeneous catalyst system comprising Group 4 transition metals; and ligand structures, such as metallocene, non-metallocene metal-centered, heteroaryl, heterovalent aryloxyether, phosphine-imine, and others. Combinations of heterogeneous and/or homogeneous catalysts may also be used in either single-reactor or dual-reactor configurations.

In various embodiments, the ungrafted ethylene-based polymer includes HDPE, LDPE, LLDPE, VLDPE, ULDPE, or combinations thereof.

In various embodiments, the ungrafted ethylene-based polymer includes LLDPE.

In various embodiments, the LLDPE comprises a Ziegler-Natta-catalyzed LLDPE, a metallocene-catalyzed LLDPE, or combinations thereof.

In various embodiments, the ungrafted ethylene-based polymer has a melt index (I₂) of 0.1 to 50 g/10 minutes, of 0.1 to 40 g/10 minutes, of 0.1 to 30 g/10 minutes, of 0.1 to 20 g/10 minutes, of 0.1 to 15 g/10 minutes, of 0.1 to 10 g/10 minutes, or of 0.1 to 5 g/10 minutes (measured according to ASTM D1238 at Condition 190/2.16).

### Polyamide

The terms “amide-based polymer” and “polyamide” are used interchangeably. They refer to a polymer that contains more than 50 percent of amide bonds between monomers and, optionally, may contain at least one other bond type. Amide-based polymers include homopolymers and copolymers (meaning more than one kind of monomer used to form the amide-based polymer). Examples of amide-based polymers (polyamides) include aliphatic and semi-aromatic. Examples of aliphatic polyamides include polycaprolactam, poly(hexamethylene adipamide), poly(hexamethylene succinimide), polylaurolactam, poly(11-aminoundecanoic acid), and poly(hexamethylene sebacamide). Examples of semi-aromatic polyamides include poly(hexamethylene terephthalamide), poly(hexamethylene isophthalamide), and polymers utilizing both terephthalic acid and isophthalic acid along with an aliphatic diamine.

The polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

Amorphous polyamide refers to a polyamide having insufficient crystallinity, that is, not having an endothermic crystalline melting peak when measured by differential scanning calorimetry (DSC) (ASTM D-3417, 10 °C/min).

In general, the polyamide can be prepared using diamine and dicarboxylic acid. Examples of the diamine include hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidene, 1,4-diaminocyclohexane, 1,3-diaminocyclohexane, meta-xylenediamine, 1, 5-diaminopentane, 1,4-diaminobutane, 1,3-diaminopropane, 2-ethyldiaminobutane, 1,4-diaminomethylcyclohexane, methane-xylenediamine, alkyl-substituted or unsubstituted m-phenylenediamine and p-phenylenediamine, etc. Examples of the dicarboxylic acid include alkyl-substituted or unsubstituted isophthalic acid, terephthalic acid, adipic acid, sebacic acid, butanedicarboxylic acid, etc.

Polyamide prepared using an aliphatic diamine and an aliphatic dicarboxylic acid is generally semicrystalline polyamide. The semicrystalline polyamide is generally prepared using lactam, such as nylon 6 or nylon 11, or an amino acid, but may also be prepared by condensing a diamine, such as hexamethylenediamine, with a dibasic acid, such as succinic acid, adipic acid, or sebacic acid. The polyamide may be a copolymer or a terpolymer such as a copolymer of hexamethylenediamine/adipic acid and caprolactam (nylon 6,66). A mixture of two or more semicrystalline polyamides can also be used.

Amorphous polyamide is typically obtained when either diamine or dicarboxylic acid is aromatic, and the other is aliphatic. Examples of aliphatic groups of the amorphous polyamide include C₁-C₁₅ aliphatic or C₄-C₈ alicyclic alkyls. Examples of aromatic groups of the amorphous polyamide include substituted C₁-C₆ mono- or bicyclic aromatic groups.

Examples of amorphous polyamides include hexamethylenediamine isophthalamide, a mixture of 2,2,4- and 2,4,4-trimethylhexamethylenediamine terephthalamide, a copolymer of hexamethylenediamine or 2-methylpentamethylenediamine and an isophthalic acid, terephthalic acid, or mixtures thereof.

The semicrystalline and amorphous polyamides may be prepared by condensation polymerization, as well-known in the art.

In various embodiments, the polyamide includes nylon 4.6, nylon 6, nylon 6.6, nylon 6.10, nylon 6.12, nylon 11, nylon 12, amorphous nylon, or combinations thereof.

In various embodiments, the polyamide includes nylon 6.

### EVOH

The composition may include an ethylene-vinyl alcohol copolymer (EVOH).

The EVOH may have an ethylene content ranging from 25 to 50 mol %, or from 27 to 44 mol % of ethylene, based on the total moles of the EVOH.

The EVOH can be prepared by any known method, such as by polymerizing ethylene and vinyl acetate to give the ethylene-vinyl acetate (EVA) copolymer followed by hydrolysis.

### Compatibilizer

A compatibilizer is typically used to improve the compatibility of a non-polar polymer, such as a polyolefin, with a polar polymer, such as polyamide and ethylene-vinyl alcohol copolymer (EVOH).

The compatibilizer for use according to the invention includes an ethylene-alkyl acrylate copolymer (EAA) grafted with maleic anhydride (MAH).

The alkyl group in the EAA is preferably methyl or n-butyl.

The EAA may be block or random.

The MAH-g-EAA preferably has an MI of 25 to 250 g/10 minutes, of 25 to 200 g/10 minutes, of 25 to 150 g/10 minutes, or of 25 to 100 g/10 minutes (measured according to ASTM D1238 at Condition 190/2.16).

The MAH-g-EAA preferably has a maleic anhydride (MAH) content of 1.3 to 2.0 wt %, of 1.4 to 2.0 wt %, or of 1.5 to 2.0 wt %, based on the weight of the MAH-g-EAA.

The MAH content in the MAH-g-EAA is sometimes referred to as the acid number (AN), where 1 wt % of MAH grafting is equivalent to an acid number of approximately 5.72. The AN indicates the amount of free acid present in the grafted polymer. It represents the number of milligrams of potassium hydroxide or sodium hydroxide necessary to neutralize 1 gram of polymer sample.

In various embodiments, the MAH-g-EAA has an AN of 9-12, of 9.5-11, or of 10-11.

The MAH-g-EAA can have any combination of MI and MAH content enumerated above. For example, the MAH-g-EAA can have an MI of 25 to 250 g/10 minutes and an MAH content of 1.3 to 2.0 wt %, of 1.4 to 2.0 wt %, or of 1.5 to 2.0 wt %%, based on the weight of the MAH-g-EAA; or an MI of 25 to 200 g/10 minutes and an MAH content of 1.3 to 2.0 wt %, of 1.4 to 2.0 wt %, or of 1.5 to 2 wt %, based on the weight of the MAH-g-EAA; and so on.

The MAH-g-EAA may be made by thermal maleation using reactive extrusion, such as the process described in U.S. Pat. No. 10,053,574 B2 (the entire content of which is hereby incorporated by reference). Briefly, the process involves:
(a) melting the EAA in an extruder to form a molten EAA;
(b) introducing maleic anhydride into the extruder; and
(c) contacting the molten EAA with the maleic anhydride in the extruder under conditions of heat and shear sufficient to increase the melt index (MI) of the starting EAA and to form the MAH-g-EAA.

Preferably, the EAA is grafted with MAH in the absence of an added free radical initiator.

In various embodiments, the compatibilizer comprises a maleic anhydride grafted ethylene-methyl acrylate copolymer. The ethylene-methyl acrylate copolymer (EMA) may be block or random.

In various embodiments, the EMA comprises from 15 to 25 wt % of methyl acrylate, based on the weight of the EMA.

Before grafting, the EMA can have a melt index (MI) in the range of 0.1 to 50 g/10 minutes (measured according to ASTM D1238 at Condition 190/2.16).

In various embodiments, the compatibilizer comprises a maleic anhydride grafted ethylene-butyl acrylate copolymer. The ethylene-butyl acrylate copolymer (EBA) may be block or random.

In various embodiments, the EBA comprises from 18 to 24 wt % of butyl acrylate, based on the weight of EBA.

Before grafting, the EBA can have a melt index (MI) in the range of 0.1 to 25 g/10 minutes (measured according to ASTM D1238 at Condition 190/2.16).

Before grafting, the EAA can have a density of 0.920 to 0.950 g/cm³.

After grafting, the density of the MAH-g-EAA may increase slightly from the initial density of the EAA (e.g., +0.001 to 0.010 g/cm³).

The EAA may be prepared by any method known in the art, such as the one described in U.S. Pat. No. 3,350,372. The EAA may also be obtained commercially such as from Westlake Corporation (Houston, Texas).

### Monolayer Films

The compositions of the invention are particularly useful for making monolayer blown films, particularly flexible films for packaging applications.

Thus, in a second aspect, the invention provides a monolayer blown film comprising the compositions described herein.

The film may have a thickness in the range of 5 to 250 μm, or 5 to 125 μm.

### Methods of Making Monolayer Blown Film

In a third aspect, the present invention provides several methods of making a monolayer blown film.

One method includes the steps of:
(a) providing a multilayer barrier film which comprises a tie layer comprising a compatibilizer according to the invention;
(b) shredding and densifying the multilayer barrier film to form crude pellets; and
(c) forming the monolayer blown film from the crude pellets.

Another method includes the steps of:
(a) providing a multilayer barrier film which is free of a compatibilizer according to the invention;
(b) shredding and densifying the multilayer barrier film to form crude pellets;
(c) adding a compatibilizer according to the invention to the multilayer barrier film during step (b) to form the crude pellets; and
(d) forming the monolayer blown film from the crude pellets.

Yet another method includes the steps of:
(a) melt blending the ungrafted ethylene-based polymer, the polar polymer, and the compatibilizer to form new pellets; and
(b) forming the monolayer blown film from the new pellets.

Multilayer barrier films, particularly those used for packaging, are known in the art. They typically include one or more layers of polyethylene, one or more layers of polyamide and/or EVOH, and one or more tie layers in between the other layers.

The multilayer barrier film for use in the present invention may be post-industrial waste or post-consumer waste.

Instead of being sourced from multilayer barrier films, the ungrafted ethylene-based polymer and the polar polymer may be provided individually from separate sources. For example, the ungrafted ethylene-based polymer may be provided for use in the form of flakes, powders, granulates, pellets, and/or film shreds, which do not include the desired amount of the polar polymer. Likewise, the polar polymer may be provided in the form of flakes, powders, granulates, pellets, and/or film shreds, etc., which do not include the desired amount of the ungrafted ethylene-based polymer.

The individually sourced ungrafted ethylene-based polymer and/or polar polymer may be post-industrial waste or post-consumer waste.

The shredding and densifying step can be advantageously carried out using commercially available equipment, such as the INTAREMA® line of products offered by EREMA North America, Inc. (Ipswich, Massachusetts).

The melt-blending step may be carried out by any suitable means, such as an extruder.

When sourcing the ungrafted ethylene-based polymer and the polar polymer individually, the ingredients (including the compatibilizer) can either be pre-blended or fed separately into the extruder. The ingredients are then mixed and homogenized together in the melt state inside of the extruder barrel. The molten plastic is then forced through a die plate having multiple holes. These strands can then be cooled by pulling through a water bath and then introduced into a pelletizer where they are cut to form new pellets.

The film-forming step may be carried out using blown-film extrusion.

Blown-film extrusion typically includes a step of extruding a polymer melt through a die. The die includes a narrow slit, which is typically circular or annular. The resulting thin film, in the form of a tube, is then cooled and rolled up on a core.

In the extrusion step, resin pellets (or other suitable forms of the ingredients) are typically gravity fed into a heated barrel of an extruder. The pellets are conveyed down the barrel by a screw that first compacts and then melts the pellets through shear-induced heat. The last section of the screw, also known as the metering section, ensures a homogeneous melt and uniform output.

The polymer melt is then forced through a tubular-shaped (or annular) die. After exiting the die, the molten tube of polymer is injected with air and generally pulled upward by a set of nip rolls, although in some cases, it can be pulled horizontally or downward. As film thickness is reduced, the tube expands because of internal bubble pressure and forms a tube of larger diameter. Air rings aid in film cooling by supplying air flow around the molten tube. The tube is then drawn down to a desired final film thickness, for example, in the range of 5 to 250 μm, or from 10 to 125 μm.

### General Provisions

To remove any doubt, the present invention includes and expressly contemplates and discloses any and all combinations of embodiments, features, characteristics, parameters, and/or ranges mentioned herein. That is, the subject matter of the present invention may be defined by any combination of embodiments, features, characteristics, parameters, and/or ranges mentioned herein.

It is contemplated that any ingredient, component, or step that is not specifically named or identified as part of the present invention may be explicitly excluded.

Any process/method, apparatus, compound, composition, embodiment, or component of the present invention may be modified by the transitional terms “comprising,” “consisting essentially of,” or “consisting of,” or variations of those terms.

As used herein, the indefinite articles “a” and “an” mean one or more, unless the context clearly suggests otherwise. Similarly, the singular form of nouns includes their plural form, and vice versa, unless the context clearly suggests otherwise.

While attempts have been made to be precise, the numerical values and ranges described herein may be considered approximations. These values and ranges may vary from their stated numbers depending upon the desired properties sought to be obtained by the present disclosure as well as the variations resulting from the standard deviation found in the measuring techniques. Moreover, the ranges described herein are intended and specifically contemplated to include all sub-ranges and values within the stated ranges. For example, a range of 50 to 100 is intended to include all values within the range including sub-ranges such as 60 to 90, 70 to 80, etc.

Any two numbers of the same property or parameter reported in the working examples may define a range. Those numbers may be rounded off to the nearest thousandth, hundredth, tenth, whole number, ten, hundred, or thousand to define the range.

The content of all documents cited herein, including patents as well as non-patent literature, is hereby incorporated by reference in their entirety. To the extent that any incorporated subject matter contradicts with any disclosure herein, the disclosure herein shall take precedence over the incorporated content.

This invention can be further illustrated by the following working examples, although these examples are included merely for purposes of illustration and are not intended to limit the scope of the invention.

### EXAMPLES

### Analytical Methods

Gloss at 45° was measured according to ASTM D-2457.

Haze was measured according to ASTM D-1003.

Tensile strength, tensile toughness, elongation, and Secant modulus were measured according to ASTM D-882.

Puncture resistance was measured according to ASTM D-5748.

Dart impact strength was measured according to ASTM D-1709 method A.

Elmendorf tear was measured according to ASTM D-1922.

Melt index was determined according to ASTM D-1238, Condition 190 °C/2.16 kg.

Resin density was measured according to ASTM D-4883, ASTM D-792, or ISO 1183.

Acid number was measured by an internal procedure which conforms to ASTM D-1386, except in the titrant, where ethanolic potassium hydroxide was replaced with methanolic sodium hydroxide. Following the sodium hydroxide titration in the presence of bromothymol blue, a back titration with hydrochloric acid was performed.

### Compatibilizers

### TYMAX® GT4408

GT4408 is a commercially available tie resin offered by Westlake Corporation (Houston, Texas). It is a maleic anhydride-modified LLDPE (ethylene-hexene) having a density of 0.919 g/cm³ and an MI of 2.3 g/10 min. It is maleated to an acid number of about 1.1 (0.19 wt % of MAH).

### RETAIN™ 3000

RETAIN™ 3000 is a commercially available recycle compatibilizer resin offered by The Dow Chemical Company (Midland, Michigan). It is believed to be a maleic anhydride-modified ethylene-octene copolymer having a reported density of 0.870 g/cm³ and an estimated MI of 660 g/10 min. It is believed to be maleated to an acid number of about 7 (1.2 wt % of MAH).

### Compatibilizers A-E

Compatibilizers A through E were synthesized using a 40-mm twin-screw extruder to perform thermal maleation via reactive extrusion. The base resin for each compatibilizer was an ethylene-methyl acrylate copolymer (EMA) with 24 wt % of methyl acrylate and an MI of 2.1 g/10 min. The maleic anhydride pump rate was 4.5-5.0 mL/min. The nitrogen purging was kept constant at 2 SCFH (standard cubic foot per hour). The acid number for each compatibilizer was 9.5-10 (1.66-1.75 wt % of MAH).
For Compatibilizer A, the extruder temperature was 210 °C in zone 2, 220 °C in zone 3, 235 °C in zone 4, 314 °C in zones 5 through 7, 310 °C in zone 8, 180 °C in zone 9, and 175 °C-177 °C in zones 10 through 12 and the die zone. The screw speed was 350 rpm (revolutions per minute). The specific energy input was 0.521 kWh/kg (kilowatt-hours per kilogram). The melt temperature was 196 °C and the production rate was 50 lbs/hr.
For Compatibilizer B, the extruder temperature was 210 °C in zone 2, 220 °C in zone 3, 233 °C in zone 4, 355 °C in zones 5 through 8, 179 °C in zone 9, and 175 °C-177 °C in zones 10 through 12 and the die zone. The screw speed was 350 rpm. The specific energy input was 0.453 kWh/kg. The melt temperature was 194 °C and the production rate was 50 lbs/hr.
For Compatibilizer C, the extruder temperature was 210 °C in zone 2, 220 °C in zone 3, 230 °C in zone 4, 372 °C in zones 5 through 8, 175 °C-177 °C in zones 9 through 12 and the die zone. The screw speed was 275 rpm. The specific energy input was 0.348 kWh/kg. The melt temperature was 199 °C and the production rate was 55 lbs/hr.
For Compatibilizer D, the extruder temperature was 210 °C in zone 2, 220 °C in zone 3, 230 °C in zone 4, 390 °C in zones 5 through 8, and 175 °C-176 °C in zones 9 through 12 and the die zone. The screw speed was 275 rpm. The specific energy input was 0.338 kWh/kg. The melt temperature was 202 °C and the production rate was 55 lbs/hr.
For Compatibilizer E, the extruder temperature was 210 °C in zone 2, 220 °C in zone 3, 230 °C in zone 4, 395 °C-396 °C in zones 5 through 8, and 175 °C-177 °C in zones 9 through 12 and the die zone. The screw speed was 275 rpm. The specific energy input was 0.330 kWh/kg. The melt temperature was 200 °C and the production rate was 55 lbs/hr.

The MI and acid number of Compatibilizers A-E are listed in Table 1 below.

### Fabrication of Multilayer Blown Film

A seven-layer barrier film was created to serve as a reference article, mimicking a post-industrial recycled barrier film.

The extruders for layers 1 and 7 (the outermost layers) contained an LLDPE (ethylene-hexene) with a density of 0.919 g/cm³ and an MI of 1.0 g/10 min. The estimated mass percent to total feed was 25 wt % for each layer. The pump rate was 1.4 lb/hr/rpm with a screw speed of 62.6 rpm. The temperatures of the barrels in the extruder were 350 °F (177 °C) in zone 1, 450 °F (232 °C) in zone 2, 420 °F (216 °C) in zones 3 and 4, 430 °F (221 °C) in zone 5, and 450 °F (232 °C) at the screen changer, adapter, and die zone.

The extruders for layers 2 and 6 (the layers adjacent to outermost layers) contained TYMAX® GT4408, a tie resin with a density of 0.919 g/cm³ and an MI of 2.3 g/10 min. The estimated mass percent to total feed was 10 wt % for each layer. The pump rate was 0.504 lb/hr/rpm with a screw speed of 69.5 rpm. The temperatures of the barrels were 350 °F (177 °C) in zone 1, 430 °F (221 °C) in zone 2, 410 °F (210 °C) in zones 3 and 4, 420 °F (216 °C) in zone 5, and 430 °F (221 °C) at the screen changer, adapter, and die zone.

The extruders feeding layers 3 and 5 (the layers adjacent to the central layer) contained BASF's Ultramid® B40 01, a polyamide 6 nylon resin with density of 1.13 g/cm³. The estimated mass percent to total feed was 10 wt % for each layer. The pump rate was 0.52 lb/hr/rpm with a screw speed of 67.1 rpm. The temperatures of the barrels were 420 °F (216 °C) in zone 1, 460 °F (239 °C) in zone 2, 490 °F (254 °C) in zones 3 and 4, and 500 °F (260 °C) in zone 5, at the screen changer, adapter, and die zone.

The extruder feeding layer 4 (the central layer) contained Kuraray's Eval™ F171B, a 32 mol % ethylene-vinyl alcohol copolymer with a density of 1.19 g/cm³ and an MI of 1.6 g/10 min. The estimated mass percent to total feed was 10 wt. %. The pump rate was 0.63 lb/hr/rpm with a screw speed of 55.5 rpm. The temperatures of the barrels were 350 °F (177 °C) in zone 1, 430 °F (221 °C) in zone 2, 410 °F (210 °C) in zone 3, 420 °F (216 °C) in zones 4 and 5, and 430 °F (221 °C) in zone 5, at the screen changer, adapter, and die zone.

The top die and the inner mandrel temperature was set at 500 °F (260 °C). The temperature of the air supply at the air ring for internal bubble cooling was set at 55 °F (12.8 °C). The target gauge was 3.0 mil with a desired output of 350 lb/hr. The die gap was 100 mil. The bubble lay-flat was 30 inches and so was the final width. The blow-up ratio of the film was 2.4. The line speed was estimated at 81 fpm (feet per minute). The estimated shear rate was 86 sec⁻¹.

Film Shredding Procedure for Sample with GT4408

A multilayer blown film obtained from the film fabrication step was fed into an INTAREMA® K film shredder. 95% (wt./wt.) of the 7-layer blown film was fed into the machine. At the same time, 5% (wt./wt.) of GT4408 was dropped in as pellets into the pre-conditioning unit. The temperature of the pre-conditioning unit was set at 195 °F (91 °C) with the blade motor drawing a power of 10.7 hp. The temperature was set at 450 °F (232 °C) for the two extruder barrel zones and die zone. Occasional misting was used to control the pre-conditioning unit temperature. The extrudate coming out of the die was cooled and collected with an air pelletizing unit. The obtained concentrate pellets were then transferred to a monolayer film fabrication step.

Film Shredding Procedure for Samples with Remaining Compatibilizers

A multilayer blown film obtained from the film fabrication step was fed into an INTAREMA® K film shredder. 95% (wt./wt.) of the 7-layer blown film was fed into the machine. At the same time, 5% (wt./wt.) of the compatibilizer was dropped in as pellets into the pre-conditioning unit. The temperature of the pre-conditioning unit was between 208-214 °F (98-101 °C) with the blade motor drawing a power of 10 hp. The temperature was set at 450 °F (232 °C) for the two extruder barrel zones and die zone. Occasional misting was used to control the pre-conditioning unit temperature. The extrudate coming out of the die was cooled and collected with an air pelletizing unit. The obtained concentrate pellets were then transferred to a monolayer film fabrication step.

### Example 1—Control

### Preparation of Monolayer Polyethylene (PE) Film

100% (wt./wt.) of a linear low-density polyethylene (Westlake Chemical HIFOR® LF2020AA having a melt index of 1.0 g/10 min. and density of 0.919 g/cm³) was added to the feed of a monolayer film blowing line. The extrusion barrel temperature set point was 325 °F (163 °C) in zone 1, 500 °F (260 °C) in zone 2, 485 °F (252 °C) in zone 3, 480 °F (249 °C) in zone 4, and 483 °F (251 °C) in zone 5 and all die zones 1 through 4. The screw speed was 54 rpm, the melt pressure was 1,700 psi, the nip pressure was 45 psi, the air temperature was 52 °F (11 °C), the film speed was 145 fpm (feet per minute), the bubble height was 15′ (feet), the bubble width was 22.5″ (inches), and the film thickness was 0.9 mil. The die gap was 100 mil, and the blow-up ratio was 2.4:1. The output of the process was 140 lbs/hr.

This film was then subjected to testing for packing film properties. The results are reported in Table 1 below.

### Examples 2-8

### Preparation of Monolayer Films

35% (wt./wt.) of each concentrate pellets obtained from the film shredding step and 65% (wt./wt.) of a linear low-density polyethylene (Westlake Chemical HIFOR® LF2020AA having a melt index of 1.0 g/10 min. and density of 0.919 g/cm³) were added to the feed of a monolayer film blowing line. The extrusion barrel temperature set point was 325 °F (163 °C) in zone 1, 500 °F (260 °C) in zone 2, 483 °F-485 °F (251-252 °C) in zone 3, 479 °F-482 °F (248-250 °C) in zone 4, 482 °F-484 °F (250-251 °C) in zone 5, and 481 °F-484 °F (249-251 °C) in die zones 1 through 4. The screw speed was between 53-55 rpm, the melt pressure was between 1,670 and 1,700 psi, the nip pressure was 45 psi, the air temperature was 52-53 °F (11-12 °C), the film speed was 145 fpm (feet per minute), the bubble height was 15′ (feet), the bubble width was 22.5″ (inches), and the film thickness was between 1.1 and 1.3 mil. The die gap was 100 mil, and the blow-up ratio was 2.4:1. The output of the process was 145 lbs/hr.

Each film was then subjected to testing for packing film properties. The results are reported in Table 1 below.

TABLE 1

| | | Ex. 2 | Ex. 3 | | | | | |
|---|---|---|---|---|---|---|---|---|
| | Ex. 1 | (Compar- | (Compar- | | | | | |
| | (Control) | ative) | ative) | Ex. 4 | Ex. 5 | Ex. 6 | Ex. 7 | Ex. 8 |
| Barrier Film | | | | | | | | |
| Comp. | | | | | | | | |
| (wt %) | | | | | | | | |
| LLDPE | — | 50 | 50 | 50 | 50 | 50 | 50 | 50 |
| PA | — | 20 | 20 | 20 | 20 | 20 | 20 | 20 |
| EVOH | — | 10 | 10 | 10 | 10 | 10 | 10 | 10 |
| Tie Layer | — | 20 | 20 | 20 | 20 | 20 | 20 | 20 |
| Concentrate | | | | | | | | |
| Pellet Comp. | | | | | | | | |
| (wt %) | | | | | | | | |
| Barrier Film | — | 95 | 95 | 95 | 95 | 95 | 95 | 95 |
| Compat- | — | 5 | 5 | 5 | 5 | 5 | 5 | 5 |
| ibilizer | | | | | | | | |
| Compat- | — | GT4408 | RETAIN ™ | A | B | C | D | E |
| ibilizer | | | 3000 | | | | | |
| MI | — | 2.3 | 660 | 30 | 80 | 120 | 180 | 240 |
| (g/10 min.) | | | | | | | | |
| MAH | — | 0.19 | 1.2 | 1.66- | 1.66- | 1.66- | 1.66- | 1.66- |
| (wt %) | | | | 1.75 | 1.75 | 1.75 | 1.75 | 1.75 |
| Monolayer | | | | | | | | |
| Blown | | | | | | | | |
| Film Comp. | | | | | | | | |
| (wt. %) | | | | | | | | |
| Concentrate | — | 35 | 35 | 35 | 35 | 35 | 35 | 35 |
| LLDPE | 100 | 65 | 65 | 65 | 65 | 65 | 65 | 65 |
| Film | 0.9 | 1.3 | 1.2 | 1.1 | 1.1 | 1.1 | 1.1 | 1.0 |
| Thickness | | | | | | | | |
| (mil) | | | | | | | | |
| Optical | | | | | | | | |
| Properties | | | | | | | | |
| Gloss at 45° | 39.7 | 9.9 | 7.9 | 7.8 | 8.1 | 8.9 | 8.8 | 9.3 |
| Haze (%) | 11.3 | 64.1 | 72.7 | 72.6 | 71.3 | 65.7 | 65.6 | 67 |
| Clarity | 98.1 | 15.8 | 12.0 | 12.0 | 12.6 | 15.0 | 14.8 | 14.2 |
| Tensile | | | | | | | | |
| Strength | | | | | | | | |
| (psi) | | | | | | | | |
| At Break | | | | | | | | |
| TD | 4563 | 3588 | 3125 | 3785 | 3692 | 3667 | 4040 | 3697 |
| MD | 6083 | 3623 | 3982 | 4729 | 4086 | 4420 | 4731 | 4295 |
| At Yield | | | | | | | | |
| TD | 1577 | 1488 | 1460 | 1548 | 1553 | 1694 | 1670 | 1586 |
| MD | 1496 | 1544 | 1582 | 1690 | 1565 | 1686 | 1581 | 1650 |
| Tensile | | | | | | | | |
| Toughness | | | | | | | | |
| (ft-lbs/in³) | | | | | | | | |
| TD | 1786 | 1336 | 1146 | 1457 | 1414 | 1410 | 1589 | 1437 |
| MD | 1807 | 1098 | 1275 | 1583 | 1303 | 1453 | 1562 | 1368 |
| Elongation | | | | | | | | |
| (%) | | | | | | | | |
| TD | 949 | 814 | 759 | 838 | 819 | 792 | 862 | 838 |
| MD | 761 | 587 | 652 | 703 | 648 | 674 | 718 | 650 |
| Secant | | | | | | | | |
| Modulus | | | | | | | | |
| (psi) | | | | | | | | |
| TD | 44500 | 54900 | 52700 | 50100 | 49200 | 54000 | 49800 | 55400 |
| MD | 40000 | 53200 | 51800 | 47600 | 40900 | 44900 | 42000 | 42300 |
| Puncture | | | | | | | | |
| Resistance | | | | | | | | |
| Force per mil | 12.97 | 4.8 | 5.07 | 5.13 | 6.15 | 5.71 | 5.63 | 6.48 |
| (lbs/mil) | | | | | | | | |
| Load at | 11.67 | 6.24 | 6.09 | 5.65 | 6.77 | 6.28 | 6.19 | 6.48 |
| Break (lbs) | | | | | | | | |
| Energy to | 3.57 | 1.45 | 1.35 | 1.53 | 1.51 | 1.33 | 1.56 | 1.43 |
| Break (in-lbs) | | | | | | | | |
| Penetration | 5.56 | 2.48 | 2.51 | 2.77 | 2.56 | 2.23 | 2.45 | 2.46 |
| (inches) | | | | | | | | |
| Dart Impact | 134 | 109 | 128 | 116 | 145 | 115 | 118 | 125 |
| Strength | | | | | | | | |
| (F50) (g) | | | | | | | | |
| Elmendorf | | | | | | | | |
| Tear (g) | | | | | | | | |
| TD | 1417 | 521 | 468 | 459 | 514 | 481 | 491 | 519 |
| MD | 822 | 267 | 280 | 260 | 274 | 236 | 281 | 278 |

As seen in Table 1, the films with Compatibilizers A-E (Examples 4-8) exhibited slightly better optical properties, but superior tensile strength, toughness, and elongation than the film containing RETAIN™ 3000 (Example 3). Additionally, these films had similar Secant modulus, puncture resistance, and tear properties compared to Example 3.

While the film containing GT4408 (Example 2) displayed better optical properties, the films containing Compatibilizers A-E (Examples 4-8) exhibited superior mechanical properties.

### Optical Microscopy Analysis

The films from Examples 2-8 were also analyzed by optical microscopy.

The films were cut and placed between precleaned microslides made of Swiss glass with dimensions 25×75×1 mm. A Keyence VHX-2000E optical microscope with a VH-Z100R/W/T lens was employed for imaging. Software interface was VHX-2000 version 2.3.5.1. The permissible magnification range for this lens was 100-1000×. The micrographs were captured at 100× and 200× magnification in reflectance mode.

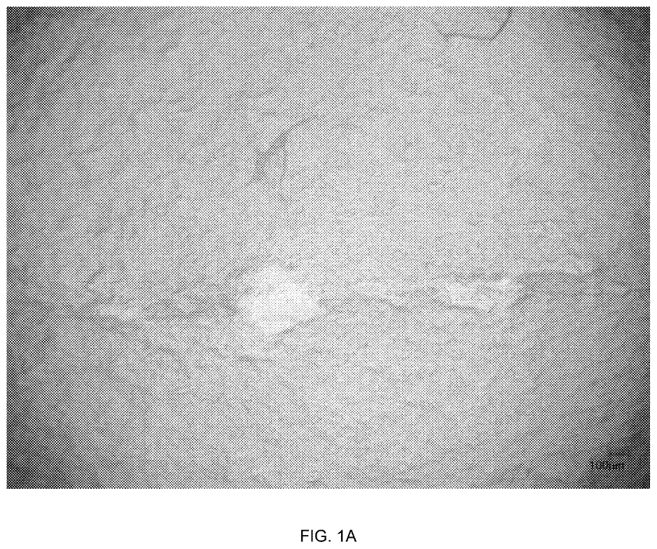

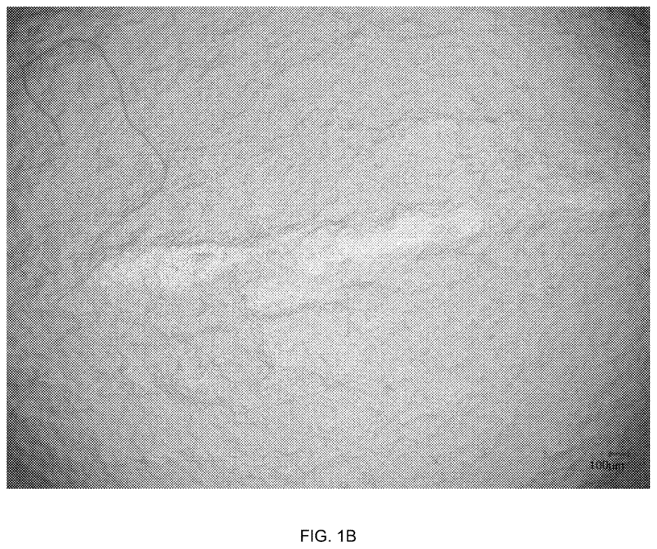

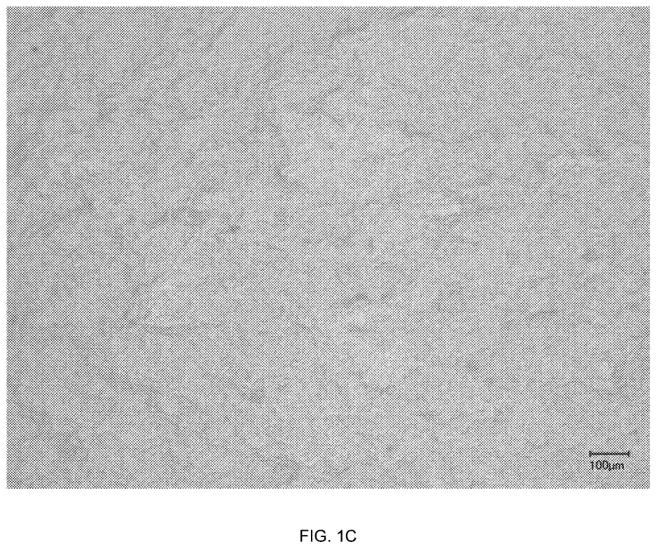

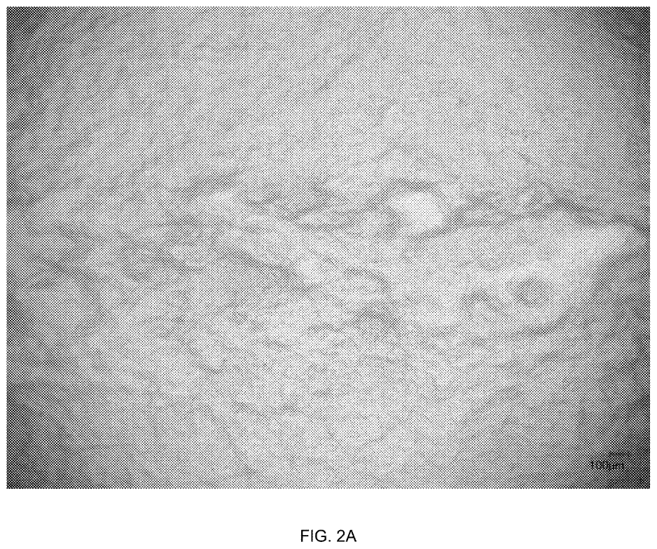

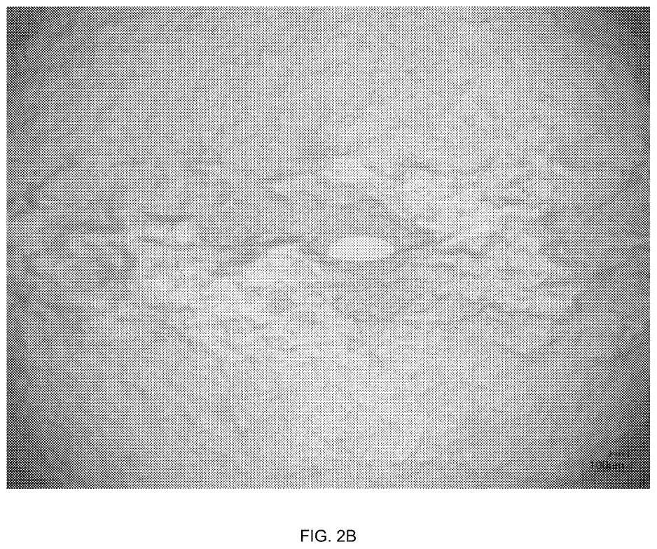

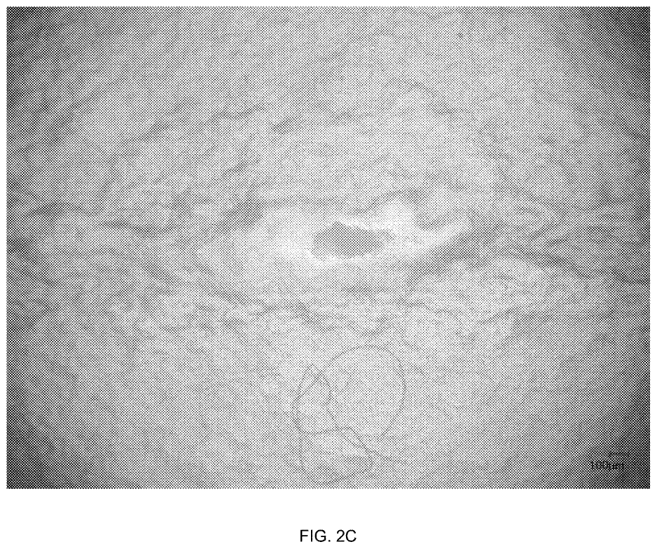

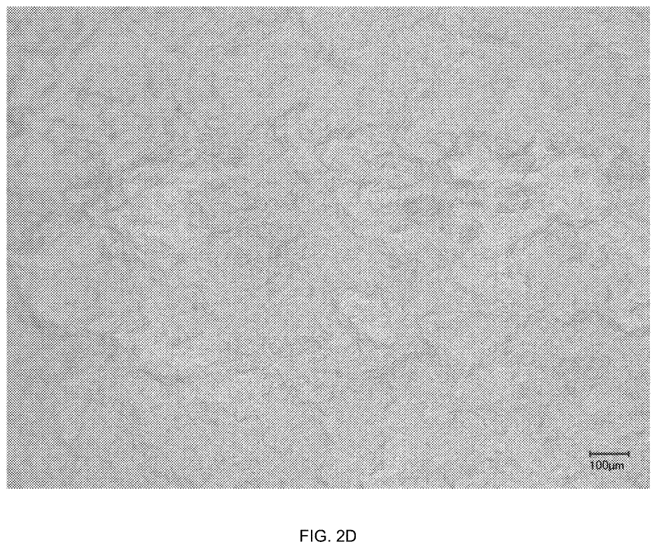

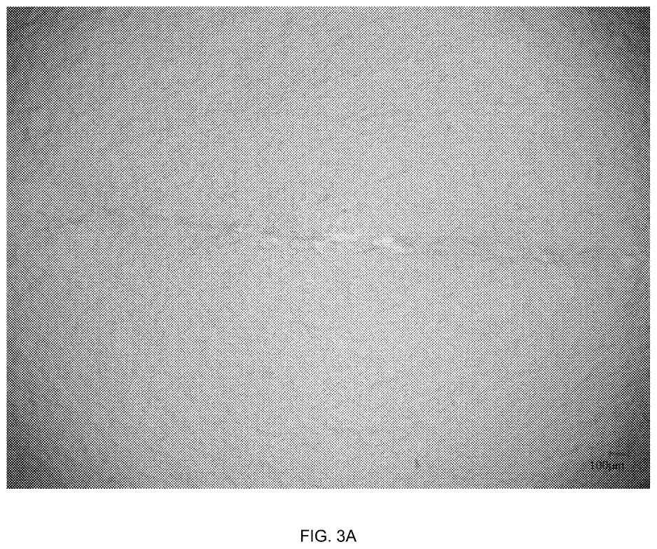

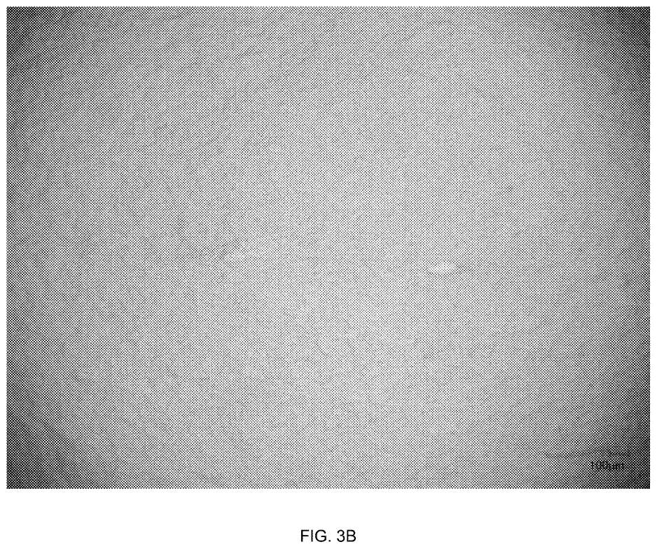

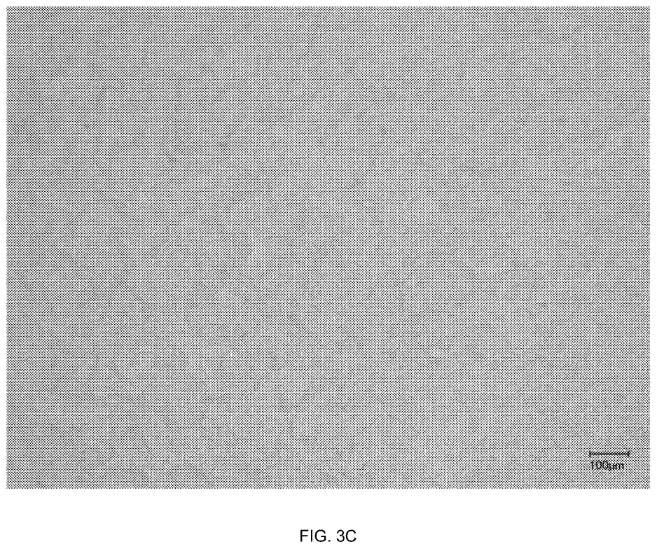

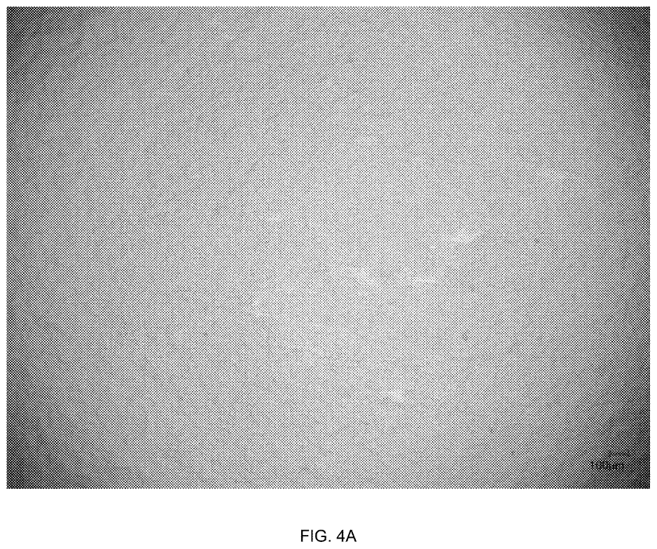

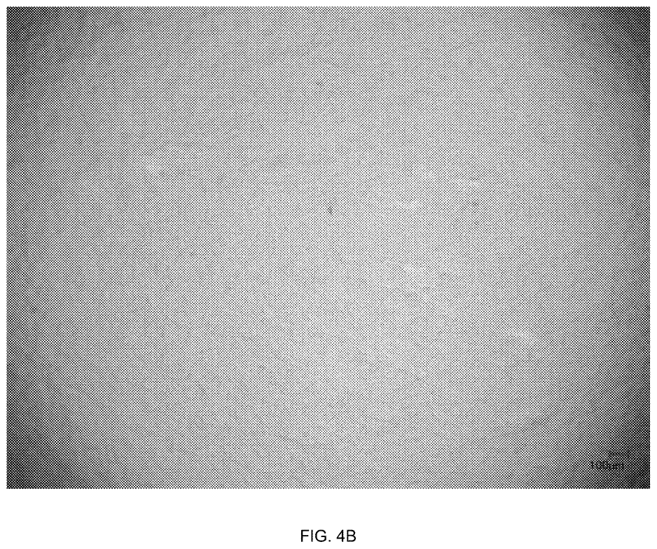

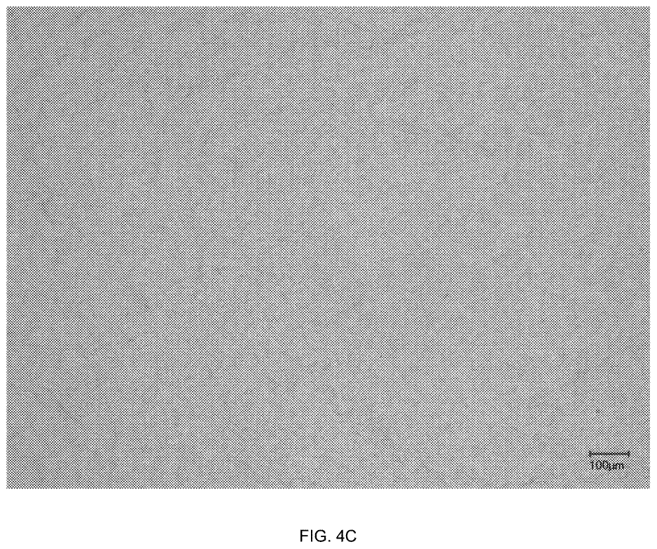

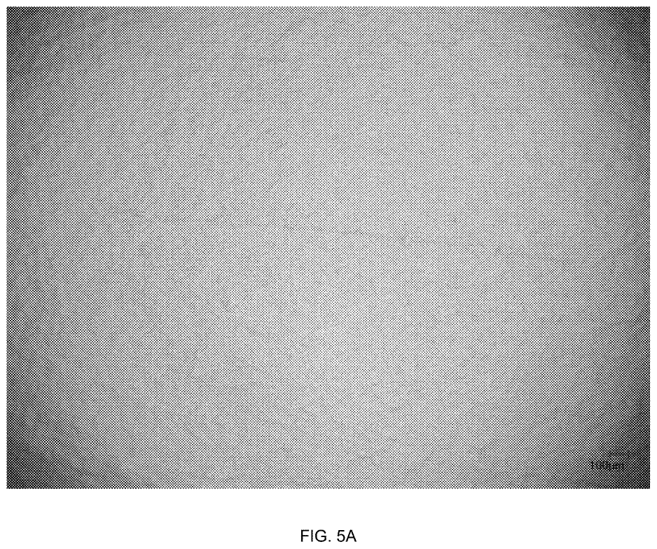

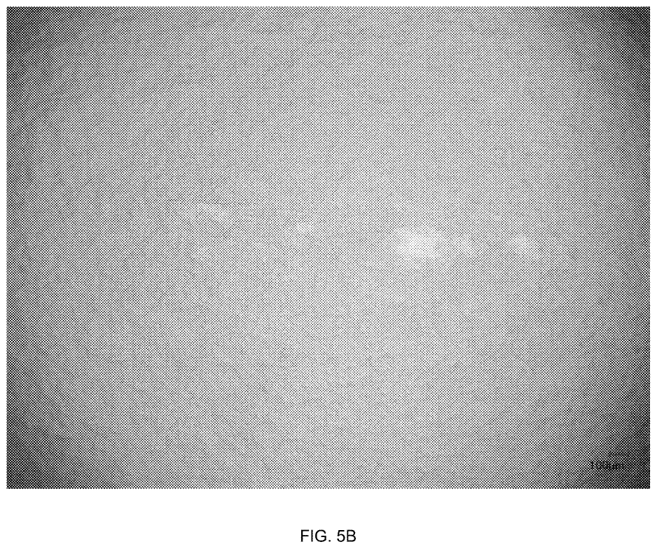

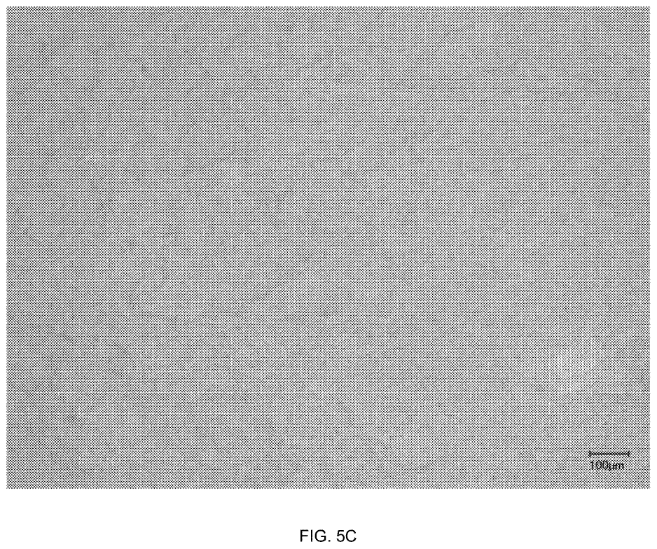

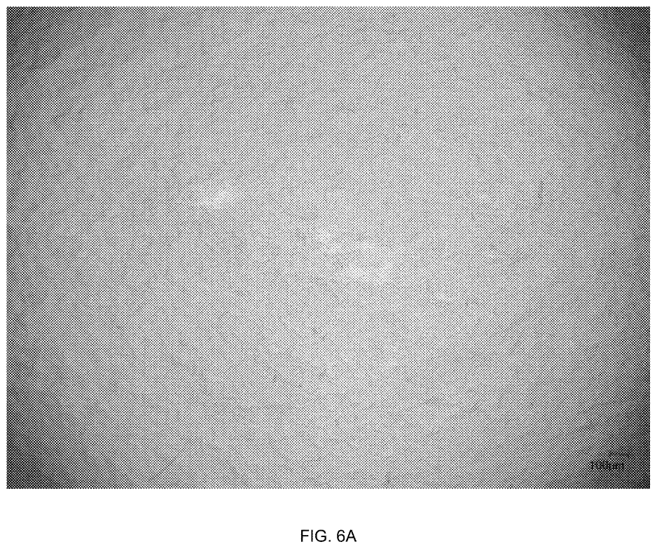

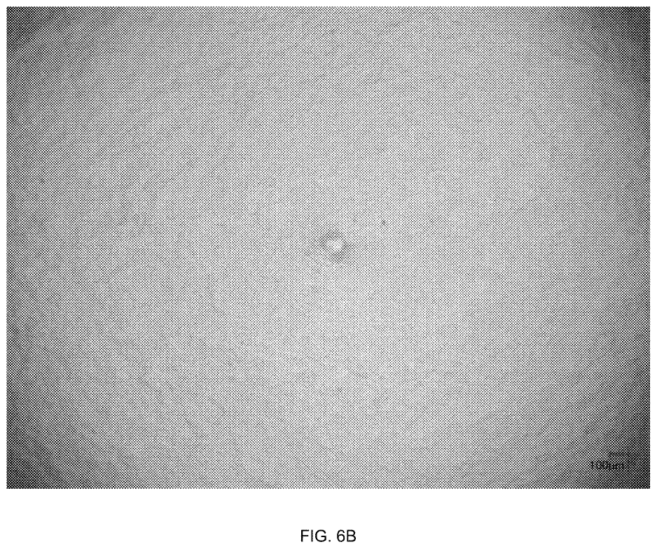

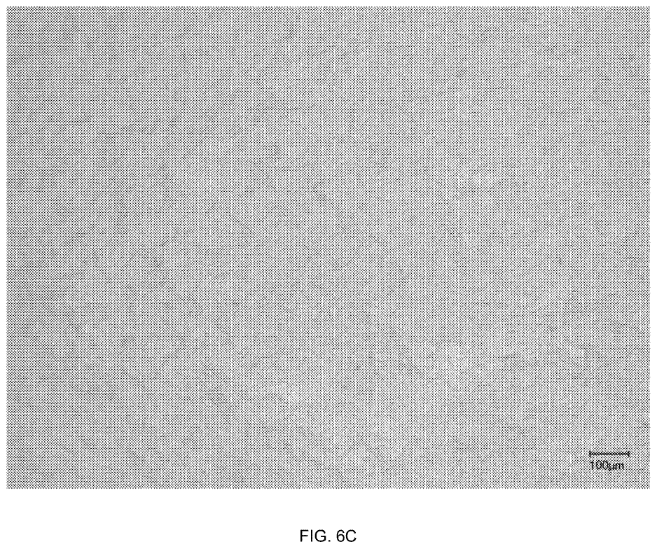

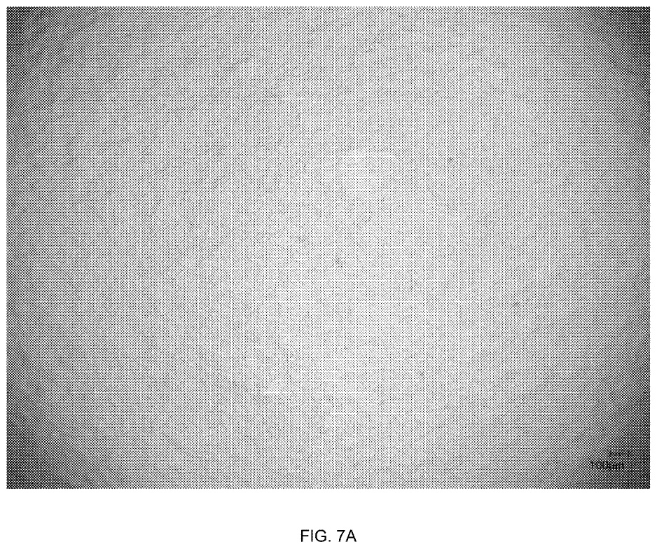

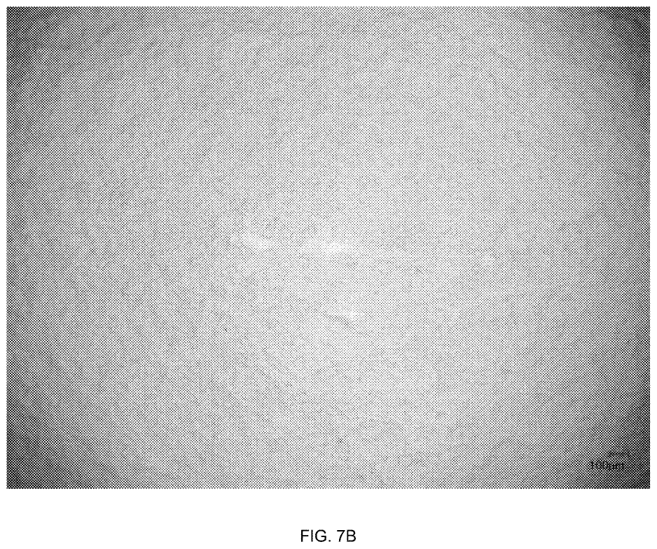

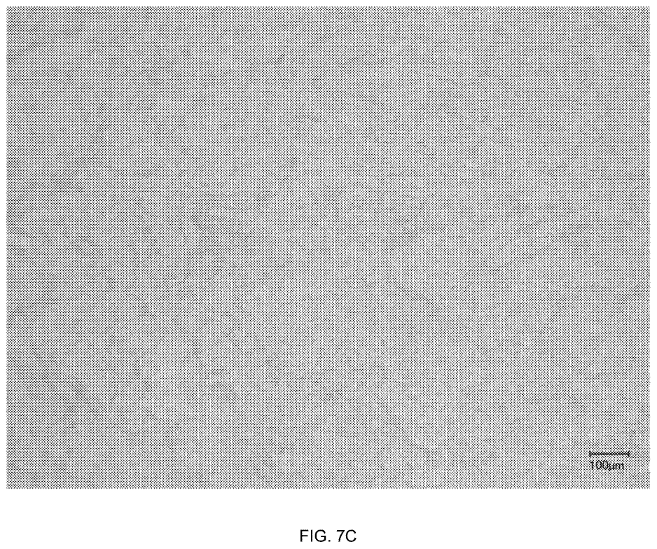

Three or four representative micrographs are shown for each composition in FIGS. 1-7.

For Examples 2 and 4-8, the micrographs labeled (A) and (B) were captured at 100× magnification and are representative of gels and unmelts, while the micrograph labeled (C) was captured at 200× and is representative of surface roughness or immiscibility within the film.

For Example 3, the micrographs labeled (A), (B), and (C) were captured at 100× magnification and are representative of gels, voids, and unmelts, respectively, while the micrograph labeled (D) was captured at 200× and is representative of surface roughness or immiscibility within the film.

Voids are physical openings in the film. Gels are globs of a likely dissimilar material thicker than the surrounding film. Gels pose an obstruction to normal deformation by acting as stress concentration points. Immiscibility is observed as surface roughness or inhomogeneity.

Observations from the microscopic images of each film are reported in Table 2 below.

TABLE 2

| Example | | | | | | |
|---|---|---|---|---|---|---|
| No. | Figures | Compatibilizer | Gels | Unmelts | Voids | Miscibility |
| 2 | 1A-1C | GT4408 | Huge | Occasional | — | Poor |
| 3 | 2A-2D | RETAIN ™ 3000 | Huge | Occasional | Occasional | Poor |
| 4 | 3A-3C | 30 MI mal-EMA | Small amount, | — | — | Good |
| | | | high aspect | | | |
| | | | ratio | | | |
| 5 | 4A-4C | 80 MI mal-EMA | Small amount, | — | — | Good |
| | | | high aspect | | | |
| | | | ratio | | | |
| 6 | 5A-5C | 120 MI mal-EMA | Medium-sized, | — | — | Average |
| | | | high aspect | | | |
| | | | ratio | | | |
| 7 | 6A-6C | 180 MI mal-EMA | Medium-sized, | — | — | Average |
| | | | high aspect | | | |
| | | | ratio | | | |
| 8 | 7A-7C | 240 MI mal-EMA | Medium-sized, | — | — | Average |
| | | | high aspect | | | |
| | | | ratio | | | |

As seen in Table 2, all seven monolayer film samples from Examples 2-8 contained gels. But the films from Examples 2 and 3 had a small fraction of huge gels, which led to perceptible surface anomalies, while the films from Examples 4-8 did not. Moreover, the aspect ratio of the gels in the mal-EMA samples (Examples 4-8) was very high relative to the gels in the comparative samples (Examples 2-3). Stretched out or elongated gels have a greater chance of breaking up into smaller gels, thereby minimizing surface anomalies. Additionally, high gel aspect ratios indicate better adhesion at the interface between the gel material and the surrounding polymer matrix.

Among Examples 4-8, the gel size and extent slightly decreased as MI decreased, while miscibility slightly decreased as MI increased. And based on the microscopic images, the film of Example 5 (80 MI mal-EMA compatibilizer) was superior to the one containing the 30 MI mal-EMAC compatibilizer (Example 4).

Overall, among all the compatibilizers tested, considering film characteristics, performance, and processability; the 30 and 80 MI mal-EMA compatibilizers from Examples 4 and 5, respectively, were the best at compatibilizing mixtures of polar (polyamide and EVOH) and non-polar (polyethylene) polymers. Film characteristics refer to the visual appearance of the film by the naked eye and under a microscope. Film performance refers to the film's mechanical properties. Processability refers to the ease and feasibility of processing the formulation ingredients.

The invention has been described in detail with particular reference to preferred embodiments thereof, but it will be understood that variations and modifications can be made within the spirit and scope of the invention.

1. A composition comprising:
(a) an ungrafted ethylene-based polymer;
(b) a polar polymer comprising a polyamide, an ethylene-vinyl alcohol copolymer (EVOH), or both; and
(c) a compatibilizer comprising an ethylene-alkyl acrylate copolymer (EAA) grafted with maleic anhydride (MAH-g-EAA),
wherein the alkyl in the EAA is methyl or n-butyl, and
wherein the MAH-g-EAA has a melt index of 25 to 250 g/10 minutes and comprises 1.3 to 2.0 wt % of maleic anhydride, based on the weight of the MAH-g-EAA.

2. The composition of claim 1, wherein the MAH-g-EAA has a melt index of 25 to 200 g/10 minutes.

3. The composition of claim 1, wherein the MAH-g-EAA comprises 1.4 to 2.0 wt % of maleic anhydride, based on the weight of the MAH-g-EAA.

4. The composition of claim 1, which comprises at least 50 wt % of the ungrafted ethylene-based polymer, based on the weight of the composition.

5. The composition of claim 1, wherein the ungrafted ethylene-based polymer comprises high-density polyethylene (HDPE), low-density polyethylene (LDPE), linear low-density polyethylene (LLDPE), very-low-density polyethylene (VLDPE), ultra-low-density polyethylene (ULDPE), or combinations thereof.

6. The composition of claim 1, wherein the ungrafted ethylene-based polymer has a melt index of 0.1 to 50 g/10 min.

7. The composition of claim 1, wherein the ungrafted ethylene-based polymer comprises LLDPE.

8. The composition of claim 7, wherein the LLDPE comprises a Ziegler-Natta-catalyzed LLDPE, a metallocene-catalyzed LLDPE, or combinations thereof.

9. The composition of claim 1, which comprises a polyamide in an amount up to 40 wt %, based on the weight of the composition.

10. The composition of claim 9, wherein the polyamide comprises nylon 4.6, nylon 6, nylon 6.6, nylon 6.10, nylon 6.12, nylon 11, nylon 12, amorphous nylon, or combinations thereof.

11. The composition of claim 1, which comprises EVOH in an amount up to 30 wt %, based on the weight of the composition.

12. The composition of claim 1, which is free of an added metal salt.

13. The composition of claim 1, wherein the EAA is grafted with maleic anhydride in the absence of an added free radical initiator.

14. A monolayer blown film which comprises the composition of claim 1.

15. A method of making the monolayer blown film of claim 14, the method comprising:
(a) providing a multilayer barrier film which comprises a tie layer comprising the compatibilizer;
(b) shredding and densifying the multilayer barrier film to form crude pellets; and
(c) forming the monolayer blown film from the crude pellets.

16. The method of claim 15, wherein the multilayer barrier film is post-industrial waste or post-consumer waste.

17. A method of making the monolayer blown film of claim 14, the method comprising:
(a) providing a multilayer barrier film which is free of the compatibilizer;
(b) shredding and densifying the multilayer barrier film to form crude pellets;
(c) adding the compatibilizer to the multilayer barrier film during step (b) to form the crude pellets; and
(d) forming the monolayer blown film from the crude pellets.

18. The method of claim 17, wherein the multilayer barrier film is post-industrial waste or post-consumer waste.

19. A method of making the monolayer blown film of claim 14, the method comprising:
(a) melt blending the ungrafted ethylene-based polymer, the polar polymer, and the compatibilizer to form new pellets; and
(b) forming the monolayer blown film from the new pellets.

20. The method of claim 19, wherein the ungrafted ethylene-based polymer, the polar polymer, or both are post-industrial waste or post-consumer waste.
